(19) United States
(12) Patent Application Publication
(10) Pub. No.: US 2022/0345979 A1
(43) Pub. Date: Oct. 27, 2022

(54) AUDIO PLAYBACK ON WI-FI SENSING

(71) Applicant: ARRIS Enterprises LLC, Suwanee, GA (US)

(72) Inventor: Sundar Murthy TUMULURU, Bangalore (IN)

(21) Appl. No.: 17/582,169

(22) Filed: Jan. 24, 2022

Related U.S. Application Data
(60) Provisional application No. 63/178,078, filed on Apr. 22, 2021.

(51) Int. Cl. H04W 40/20; G06F 3/16

(52) U.S. Cl. CPC H04W 40/20; G06F 3/165; H04W 84/12

(57) ABSTRACT

A network environment can be enhanced by interconnection of multiple network devices that includes a Wi-Fi sensing data analyzer (WSDA) that receives one or more Wi-Fi sensing parameters indicative of the presence of or lack of presence of a user within proximity of the network device from a Wi-Fi sensing agent (WSA) of a network device. The Wi-Fi sensing parameters from the WSA can be received by an audio routing controller (ARC) of an access point device for transmission to the WSDA. The ARC can receive an instruction from the WSDA that indicates how the ARC should direct packets associated with the requested audio content. For example, the instruction can indicate based, on the one or more Wi-Fi sensing parameters, that the packets should be directed to one or more audio playback devices and/or or that the packets destined for one or more other audio playback devices should be dropped.

### BACKGROUND

Companies are increasingly providing Multiple Access Point (MAP) architecture or Home Network Controller (HNC) type of home wireless fidelity (Wi-Fi) management, with multiple access point devices and/or extender access point devices within the home to improve Quality of Experience (QoE) of the user of various client devices by offering extended coverage with seamless roaming in a network environment.

Generally, a user of a network environment can utilize a variety of client devices including client devices that have a small form-factor, are located throughout the network environment, are connected to multiple network devices, have different capabilities or functions, etc. Users are increasingly demanding that all devices in a network environment operate and/or communicate seamlessly with each other to foster a cohesive and consistent network environment experience no matter the location of the user or any client device associated with providing content to the user. For example, a network environment can include multiple audio playback devices that require manually intervention to initiate the audio playback at a particular audio playback device. The user is required to manually select the audio content for each particular audio playback device in a network environment and even if the user is not present, once the audio content is selected the audio playback device continues playing the audio content until user intervention terminates the audio playback. Thus, there is a need to provide an automatic interconnection between audio playback devices associated within a network environment to provide a better quality of experience (QoE) for a user.

### SUMMARY

According to aspects of the present disclosure there are provided novel solutions for automatic interconnection of a plurality of audio playback devices within a network environment so as to provide continuous or substantially uninterrupted audio playback of content associated with a user. Wi-Fi sensing can be utilized to enable motion detection, gesture detection, biometric detection, and any other sensing detection available via Wi-Fi, or any combination thereof. Wi-Fi sensing utilizes radio information to detect environmental changes, such as, one or more moving objects (for example, a user, a pet, etc.). Wi-Fi sensing can be deployed in all types of network environments and network topologies operating in different frequency bands (for example, 2.4 Gigahertz (GHz), 5 GHz, 6 GHz, 60 GHz, etc.) and different bandwidths. Using the radio information received by a Wi-Fi sensing device, one or more network devices, such as audio playback devices, can be controlled, altered, or otherwise manipulated to enhance the QoE of a user. For example, an audio systems or a multi-room audio system can include a plurality of Wi-Fi speakers connected to the wireless network of a network environment. These Wi-Fi speakers can connect wirelessly to each other via the wireless network and can be configured using an application running on a network device, such as a smart phone, tablet, etc. A user can create a multi-room audio playback system setup within a network environment. Once the audio playback devices are connected to the Wi-Fi network in a network environment, one or more network devices with Wi-Fi sensing capability can be used to sense information associated with the presence of a user and send this information for analysis so as to cause playback of the selected audio content at one or more audio playback devices within a proximity of the sensed user without any manual intervention by the user.

An aspect of the present disclosure provides a Wi-Fi sensing data analyzer (WSDA) device to route an audio content within a network. The WSDA device comprises a memory storing one or more computer-readable instructions and a processor connected to the memory that is configured to execute the one or more computer-readable instructions to receive one or more Wi-Fi sensing parameters, wherein the one or more Wi-Fi sensing parameters are associated with a first Wi-Fi sensing agent (WSA) of a first network device connected to the network, determine a location of a user based on the one or more Wi-Fi sensing parameters, select a first audio playback device of a plurality of audio playback devices connected to the network based on the location, wherein the first audio playback device is associated with the first network device, route the audio content to the first audio playback device, receive an update of the one or more Wi-Fi sensing parameters, wherein the updated one or more Wi-Fi sensing parameters are associated with a second WSA of a second network device connected to the network, determine a change in the location of the user based on the updated one or more Wi-Fi sensing parameters, select a second audio playback device of the plurality of audio playback devices associated with the second network device based on the change in the location of the user, wherein the first audio playback device is associated with the first network device, and route the audio content from the first audio playback device to the second audio playback device.

In an aspect of the present disclosure, the routing the audio content from the first audio playback device to the second audio playback comprises any of a volume level based on at least one of one or more profile parameters associated with any of the user, the first network device, the second network device, the second audio playback device, or a combination thereof.

In an aspect of the present disclosure, the determining the change in the location of the user is based on a comparison of the updated one or more Wi-Fi sensing parameters to one or more network parameter thresholds.

In an aspect of the present disclosure, routing the audio content comprises sending a routing instruction to an audio routing controller (ARC) of an access point device within the network, wherein the routing instruction is indicative of routing of the audio content.

In an aspect of the present disclosure, the processor is further configured to execute the one or more computer-readable instructions to discontinue routing of the audio content based on a determination that the user is not within proximity of the network.

In an aspect of the present disclosure, the processor is further configured to execute the one or more computer-readable instructions to determine an expiration of a time period and wherein the determining that the user is not within proximity of the network is based on the expiration of the time period.

In an aspect of the present disclosure, wherein the one or more Wi-Fi sensing parameters comprise any of a timestamp, a received signal strength indicator, a neighbor report, a channel number, a channel bandwidth, a channel utilization, a channel state information, or a combination thereof.

An aspect of the present disclosure provides a method for a WSDA device for routing an audio content within a network. The method comprises receiving one or more Wi-Fi sensing parameters, wherein the one or more Wi-Fi sensing parameters are associated with a first Wi-Fi sensing agent (WSA) of a first network device connected to the network, determining a location of a user based on the one or more Wi-Fi sensing parameters, selecting a first audio playback device of a plurality of audio playback devices connected to the network based on the location, wherein the first audio playback device is associated with the first network device, routing the audio content to the first audio playback device receiving an update of the one or more Wi-Fi sensing parameters, wherein the updated one or more Wi-Fi sensing parameters are associated with a second WSA of a second network device connected to the network, determining a change in the location of the user based on the updated one or more Wi-Fi sensing parameters, selecting a second audio playback device of the plurality of audio playback devices associated with the second network device based on the change in the location of the user, wherein the first audio playback device is associated with the first network device, and routing the audio content from the first audio playback device to the second audio playback device.

In an aspect of the present disclosure, the method is such that the routing the audio content from the first audio playback device to the second audio playback comprises any of a volume level based on at least one of one or more profile parameters associated with any of the user, the first network device, the second network device, the second audio playback device, or a combination thereof.

In an aspect of the present disclosure, the method is such that the determining the change in the location of the user is based on a comparison of the updated one or more Wi-Fi sensing parameters to one or more network parameter thresholds.

In an aspect of the present disclosure, the method is such that routing the audio content comprises sending a routing instruction to an audio routing controller (ARC) of an access point device within the network, wherein the routing instruction is indicative of routing of the audio content.

In an aspect of the present disclosure, the method further comprises discontinuing routing of the audio content based on a determination that the user is not within proximity of the network.

In an aspect of the present disclosure, the method further comprises determining an expiration of a time period, and wherein the determining that the user is not within proximity of the network is based on the expiration of the time period.

In an aspect of the present disclosure, the method is such that the one or more Wi-Fi sensing parameters comprise any of a timestamp, a received signal strength indicator, a neighbor report, a channel number, a channel bandwidth, a channel utilization, a channel state information, or a combination thereof.

An aspect of the present disclosure provides a non-transitory computer-readable medium of a WSDA device storing one or more instructions for routing an audio content within a network. The one or more instructions when executed by a processor of the WSDA device, cause the WSDA device to perform one or more operations including the steps of the methods described above.

An aspect of the present disclosure provides an audio playback routing system to route an audio content within a network. The audio playback routing system comprises a Wi-Fi sensing data analyzer (WSDA), an access point device connected to the WSDA, wherein the access point device comprises an audio routing controller (ARC), a first network device of a plurality of network devices connected to the access point device, wherein the first network device is associated with a first Wi-Fi sensing agent (WSA) of a plurality of WSAs, a second network device of a plurality of network devices connected to the access point device, wherein the second network device is associated with a second WSA of the plurality of WSAs, wherein the first WSA, the second WSA or both generate one or more Wi-Fi sensing parameters based on sensing a presence of a user, wherein the access point device receives the one or more Wi-Fi sensing parameters, wherein the WSDA receives the one or more Wi-Fi sensing parameters from the access point device, wherein the WSDA selects an audio playback device based on the one or more Wi-Fi sensing parameters, wherein the selected audio playback device is associated with the first network device, the second network device or both, and wherein the WSDA instructs the ARC to route the audio content to the selected audio playback device.

In an aspect of the present disclosure, the audio playback routing system such that the access point device receives an update to the one or more Wi-Fi sensing parameters from at least one of the plurality of network devices, the WSDA determines a change in a location of the user based on the updated one or more Wi-Fi sensing parameters received from the access point device, the WSDA selects a different audio playback device based on the updated one or more Wi-Fi sensing parameters, and the WSDA instructs the ARC to route the audio content to the selected different audio playback device.

In an aspect of the present disclosure, the audio playback routing system such that the ARC directs the audio content to the selected audio playback device.

In an aspect of the present disclosure, the audio playback routing system such that at least one of the plurality of WSAs receive the one or more Wi-Fi sensing parameters from an associated sensing device.

In an aspect of the present disclosure, the audio playback routing system the WSDA selects the audio playback device based on one or more network parameter thresholds associated with at least one of the one or more Wi-Fi sensing parameters.

In an aspect of the present disclosure, the audio playback routing system such that the WSDA determines that the user is not within proximity of the network, and wherein the WSDA sends a discontinue routing instruction to the ARC to discontinue routing of the audio content based on a determination that the user is not within proximity of the network.

In an aspect of the present disclosure, audio playback routing system such that the one or more Wi-Fi sensing parameters comprise any of a timestamp, a received signal strength indicator, a neighbor report, a channel number, a channel bandwidth, a channel utilization, a channel state information, or a combination thereof.

An aspect of the present disclosure provides a method for audio playback routing system for routing an audio content within a network. The method comprises generating, by one or more Wi-Fi sensing Agents (WSAs) of the audio playback routing system, one or more Wi-Fi sensing parameters based on sensing a presence of a user, receiving, by an access point device of the audio playback routing system, the one or more Wi-Fi sensing parameters from one or more network devices associated with the one or more WSAs, receiving, by a Wi-Fi sensing data analyzer (WSDA) of the audio playback routing system, the one or more Wi-Fi sensing parameters from the access point device, selecting an audio playback device of a plurality of audio playback devices of the audio playback routing system based on the one or more Wi-Fi sensing parameters, and receiving, by the access point device, a first routing instruction from the WSDA to route the audio content to the selected audio playback device.

In an aspect of the present disclosure, the method further comprises receiving, by the access point device, an update to the one or more Wi-Fi sensing parameters from at least one of the one or more WSAs, determining, by the WSDA, a change in a location of the user based on the updated one or more Wi-Fi sensing parameters received from the access point device, selecting, by the WSDA, a different audio playback device of the plurality of audio playback devices based on the updated one or more Wi-Fi sensing parameters, and sending, by the WSDA, a second routing instruction to the access point device to route the audio content to the selected different audio playback device.

In an aspect of the present disclosure, the method such that the access point device directs the audio content to the selected audio playback device.

In an aspect of the present disclosure, the method such that at least one of the one or more WSAs receive the one or more Wi-Fi sensing parameters from an associated sensing device.

In an aspect of the present disclosure, the method such that the WSDA selects the audio playback device based on one or more network parameter thresholds associated with at least one of the one or more Wi-Fi sensing parameters.

In an aspect of the present disclosure, the method such that the WSDA determines that the user is not within proximity of the network, and wherein the WSDA sends a discontinue routing instruction to the access point device to discontinue routing of the audio content based on the determination that the user is not within proximity of the network.

In an aspect of the present disclosure, the method such that the one or more Wi-Fi sensing parameters comprise any of a timestamp, a received signal strength indicator, a neighbor report, a channel number, a channel bandwidth, a channel utilization, a channel state information, or a combination thereof.

An aspect of the present disclosure provides a non-transitory computer-readable medium of audio playback routing system storing one or more instructions for routing an audio content within a network. The one or more instructions when executed by a processor of the audio playback routing system, cause the audio playback routing system to perform one or more operations including the steps of the methods described above.

An aspect of the present disclosure provides an access point device for routing an audio content within a network. The access point device comprises a memory storing one or more computer-readable instructions and a processor connected to the memory that is configured to execute the one or more computer-readable instructions to receive one or more Wi-Fi sensing parameters from one or more Wi-Fi sensing agents (WSAs), wherein the one or more WSAs are associated with one or more network devices, determine a location of a user based on the one or more Wi-Fi sensing parameters, select one or more audio playback devices based on the one or more Wi-Fi sensing parameters, wherein the one or more audio playback devices are associated with the one or more network devices, and route the audio content to the selected one or more audio playback devices based on the location of the user.

In an aspect of the present disclosure, the processor is further configured to execute the one or more computer-readable instructions to receive an update of the one or more Wi-Fi sensing parameters from at least one of the one or more WSAs, determine a change in the location of the user based on the update of the one or more Wi-Fi sensing parameters, select at least one of the one or more audio playback devices based on the change in the location, and route the audio content to the selected at least one of the one or more audio playback devices.

In an aspect of the present disclosure, the determining the change in the location of the user is based on a comparison of the updated one or more Wi-Fi sensing parameters to one or more network parameter thresholds.

In an aspect of the present disclosure, the routing the audio content comprises sending a routing instruction to an audio routing controller (ARC).

In an aspect of the present disclosure, the processor is further configured to execute the one or more computer-readable instructions to discontinue routing of the audio content based on a determination that the user is not within proximity of the network.

In an aspect of the present disclosure, the processor is further configured to execute the one or more computer-readable instructions to determine an expiration of a time period and wherein the discontinuing routing is based on the expiration of the time period.

In an aspect of the present disclosure, the one or more Wi-Fi sensing parameters comprise one or more of a timestamp, a received signal strength indicator, a neighbor report, a channel number, a channel bandwidth, a channel utilization, a channel state information, or any combination thereof.

An aspect of the present disclosure provides a method for an access point device to route an audio content within a network. The method comprises receiving one or more Wi-Fi sensing parameters from one or more Wi-Fi sensing agents (WSAs), wherein the one or more WSAs are associated with one or more network devices, determining a location of a user based on the one or more Wi-Fi sensing parameters, selecting one or more audio playback devices based on the one or more Wi-Fi sensing parameters, wherein the one or more audio playback devices are associated with the one or more network devices, and routing the audio content to the selected one or more audio playback devices based on the location of the user.

In an aspect of the present disclosure, the method further comprises receiving an update of the one or more Wi-Fi sensing parameters from at least one of the one or more WSAs, determining a change in the location of the user based on the update of the one or more Wi-Fi sensing parameters, selecting at least one of the one or more audio playback devices based on the change in the location, and routing the audio content to the selected at least one of the one or more audio playback devices.

In an aspect of the present disclosure, a method for an access point device to route an audio content within a network, the method is such that the determining the change in the location of the user is based on a comparison of the updated one or more Wi-Fi sensing parameters to one or more network parameter thresholds.

In an aspect of the present disclosure, the method is such that routing the audio content comprise sending a routing instruction to an audio routing controller (ARC).

In an aspect of the present disclosure, the method further comprises discontinuing routing of the audio content based on a determination that the user is not within proximity of the network.

In an aspect of the present disclosure, the method further comprises determining an expiration of a time period, and wherein the discontinuing routing is based on the expiration of the time period.

In an aspect of the present disclosure, the method is such that the one or more Wi-Fi sensing parameters comprise one or more of a timestamp, a received signal strength indicator, a neighbor report, a channel number, a channel bandwidth, a channel utilization, a channel state information, or any combination thereof.

An aspect of the present disclosure provides a non-transitory computer-readable medium of an access point device storing one or more instructions for routing an audio content within a network. The one or more instructions when executed by a processor of the access point device, cause the access point device to perform one or more operations including the steps of the methods described above.

Thus, according to various aspects of the present disclosure described herein, it is possible to provide an automatic playback of audio content at one or more audio playback devices within a network by utilizing Wi-Fi sensing to detect a presence or movement of a user.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a block diagram illustrating an audio playback routing system, according to one or more aspects of the present disclosure;

FIG. 3 illustrates a block diagram of a configuration of a plurality of audio playback devices in a network environment, according to one or more aspects of the present disclosure;

FIG. 4 is a flow diagram illustrating a method for routing of audio content for playback at an audio playback device in a network, according to one or more aspects of the present disclosure;

FIG. 5 is a flow chart illustrating a method for playback of audio content, according to one or more aspects of the present disclosure;

FIG. 6 is a flow chart illustrating a method for an audio playback routing system to route audio content within a network; and

FIG. 7 is a flowchart illustrating a method for an access point device to route an audio content within a network, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

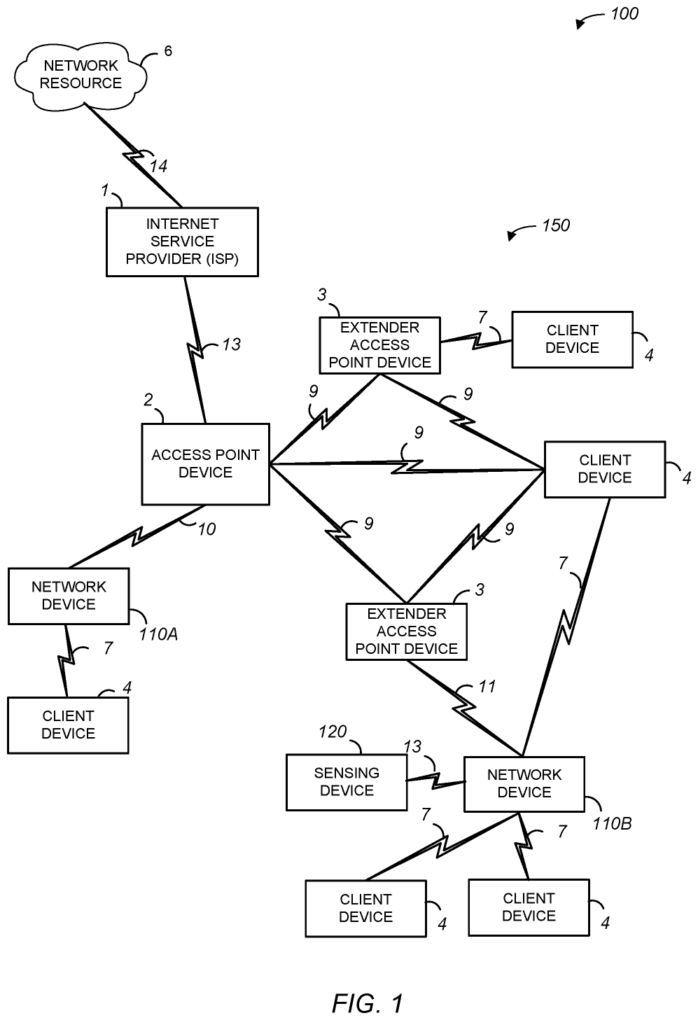

FIG. 1 is a schematic diagram of a network environment 100 that utilizes a Wi-Fi network to interconnect one or more network devices and one or more client devices, according to one or more aspects of the present disclosure.

It should be appreciated that various example embodiments of inventive concepts disclosed herein are not limited to specific numbers or combinations of devices, and there may be one or multiple of some of the aforementioned electronic apparatuses or network devices in the network environment 100, which may itself consist of multiple communication networks and various known or future developed wireless connectivity technologies, protocols, devices, and the like.

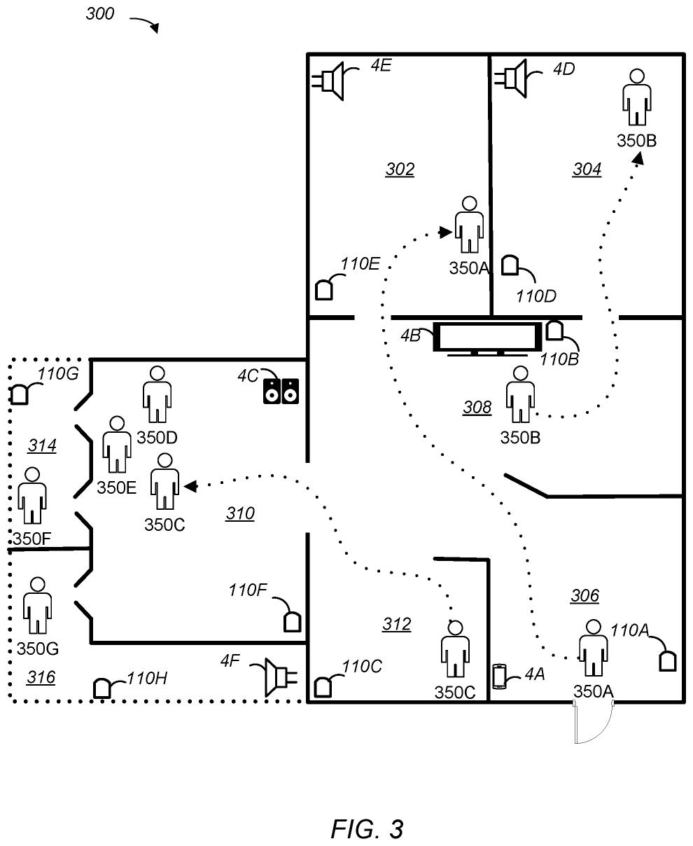

A network environment 100 can be implemented for various types of networks including, for example, a home network where multiple users interact with or utilize various types of electronic devices (for example, as discussed with reference to FIG. 3), such as one or more network devices 110, one or more client devices 4, one or more sensing devices 120, or any combination thereof. While FIG. 1 illustrates an exemplary configuration of a network environment, the present disclosure contemplates any other one or more connections and one or more electronic devices, for example, the electronic devices illustrated in FIG. 1.

As shown in FIG. 1, the network environment 100 includes various network devices 110 that interconnect via a network 150, such as a Wi-Fi network provided via the access point device 2. A network device 110 can be used to refer generally to various devices, for example, a network device 110 can comprise a particular type of device, such as any of an access point device 2, an extender access point device 3, any other type of network device for performing Wi-Fi sensing and/or routing of an audio content (for example, an Internet of Things (IoT) device), or any combination thereof.

In one or more embodiments, the network environment 100 comprises an access point device 2 connected to a network resource 6 via an Internet Service Provider (ISP) 1, one or more network devices 110A and 110B (collectively referred to as network device(s) 110) connected to the access point device 2 via one or more extender access point devices 3, and one or more client devices 4 connected to one or more network devices 110, one or more extender access point devices 3, and/or an access point device 2. The network environment 100 shown in FIG. 1 can include one or more wireless network devices (for example, extender access point devices 3, one or more network devices 110 and one or more client devices 4) that may be connected in one or more wireless networks (for example, private, guest, iControl, backhaul network, or IoT network) within the network environment 100. Additionally, there could be some overlap between wireless network devices (for example, extender access point devices 3, network devices 110, and client devices 4) in the different networks. That is, one or more wireless network devices could be located in more than one network. For example, the extender access point devices 3 could be located both in a private network for providing content and information to any of the one or more client devices 4 and/or network devices 110 and also included in a backhaul network or an iControl network. In one or more embodiments, any one or more network devices can be a wired network device.

The ISP 1 can be any computer for connecting the access point device 2 to a network resource 6. The network resource 6 can send or transmit information or data to the ISP 1, for example, content associated with any one or more uniform resource locators (URL(s)), data associated with a particular network device, audio content (such as any of audio content requested by a user from an online music store, a music repository, any other source and/or storage medium, or a combination thereof), data associated with a particular user or group of users, any other requested information, or a combination thereof. For example, network resource 6 can include any of a server, a software and/or application, a URL, an application program interface (API), a repository (such as a database or any other storage system) or any combination thereof. The connection 14 between the network resource 6 and the ISP 1 and the connection 13 between the ISP 1 and the access point device 2 can be implemented using a wide area network (WAN), a virtual private network (VPN), a metropolitan area networks (MAN), a system area networks (SAN), a data over cable service interface specification (DOCSIS) network, a fiber optics network (for example, FTTH (fiber to the home) or FTTX (fiber to the x), or a hybrid fiber-coaxial (HFC)), a digital subscriber line (DSL), a public switched data network (PSDN), a global Telex network, or a 2G, 3G, 4G, 5G, or 6G network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that connection 13 is capable of providing connections between the access point device 2 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G or 6G network, for example.

The access point device 2 can be, for example, an access point and/or a hardware electronic device that may be a combination modem and gateway, such as a residential gateway, that combines the functions of a modem, an access point (AP), and/or a router for providing content received from the ISP 1 to one or more electronic devices (for example, wireless extender access point devices 3, network devices 110, and client devices 4) in the network 150 of the network environment 100. It is also contemplated by the present disclosure that the access point device 2 can include the function of, but is not limited to, an Internet Protocol/Quadrature Amplitude Modulator (IP/QAM) set-top box (STB) or smart media device (SMD) that is capable of decoding audio and/or video content, and playing over-the-top (OTT) or multiple system operator (MSO) provided content. The access point device 2 may also be referred to as a residential gateway, a home network gateway, or a wireless access point (AP). Further, an access point device 2 can, in one or more embodiments, comprise a network device 110 and perform any of the functionality described herein with respect to, for example, network devices 110A and/or 110B. In one or more embodiments, any number of network devices 110 can be connected to any one or more other network devices 110, for example an access point device 2, an extender access point device 3, a client device 4, another network device 110, or any combination thereof.

The connection 9 between the access point device 2, the wireless extender access point devices 3, and client devices 4 can be implemented using a wireless connection in accordance with any IEEE 802.11 Wi-Fi protocols, Bluetooth protocols, Bluetooth low energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of connections 9 can carry information associated with an asset, for example, content received from and/or communicated to ISP 1.

The one or more extender access point devices 3 can be, for example, wireless hardware electronic devices such as access points (APs), extenders, repeaters, etc. used to extend the wireless network by receiving the signals transmitted by the access point device 2 and rebroadcasting the signals to, for example, a network device 110, a client device 4, or both, which may be out of range of the access point device 2. The extender access point devices 3 can also receive signals from a network device 110, a client device 4, or both and rebroadcast the signals to the access point device 2, or any other network device 110, client device 4, or both. While FIG. 1 illustrates a direct connection between extender access point devices 3 and the access point device 2, the present disclosure contemplates an indirect connection as well, for example, via an additional extender access point device 3.

The connections 11 between the extender access point devices 3 and the network devices 110 are implemented through a wireless connection that operates in accordance with any IEEE 802.11 Wi-Fi protocols, Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. Additionally, the connection 11 can be implemented using a wireless connection that operates in accordance with, but is not limited to, RF4CE protocol, ZigBee protocol, Z-Wave protocol, or IEEE 802.15.4 protocol. Also, one or more of the connections 11 can be a wired Ethernet connection.

The one or more client devices 4 can be, for example, an audio playback device capable of outputting or playing back of audio content for consumption by a user, such as a device that includes a speaker. Through this disclosure, a client device 4 can be referred to as an audio playback device 4. An audio playback device 4 can be connected to one or more network devices 110 and/or each other via a Wi-Fi connection, such as a connection 13. Audio content can comprise any type of content that comprises audio and is capable of playback at an audio playback device 4. The audio content can be stored locally within network 150, for example, at a network device 110 that includes a memory or storage medium, remote from the network 150, for example, at a network resource, any other resource or storage medium, or any combination thereof. A client device 4 can comprise a speaker system, a hand-held computing device, a personal computer including, but not limited to, any of a desktop computer or a laptop, an electronic tablet, a mobile phone, a smart phone, a smart speaker, an IoT device, an iControl device, a portable music player with smart capabilities capable of connecting to the Internet, a cellular network, and/or interconnecting with other network devices via Wi-Fi and/or Bluetooth, other wireless hand-held consumer electronic devices, or any combination thereof. Additionally, the client devices 4 can be a television (TV), an IP/QAM set-top box (STB) or a streaming media decoder that is capable of decoding audio content and/or video content, and playing over OTT or MSO provided content received through the access point device 2. A client device 4 can connect via a connection 7 to a network device 110 and/or an extender access point device 3.

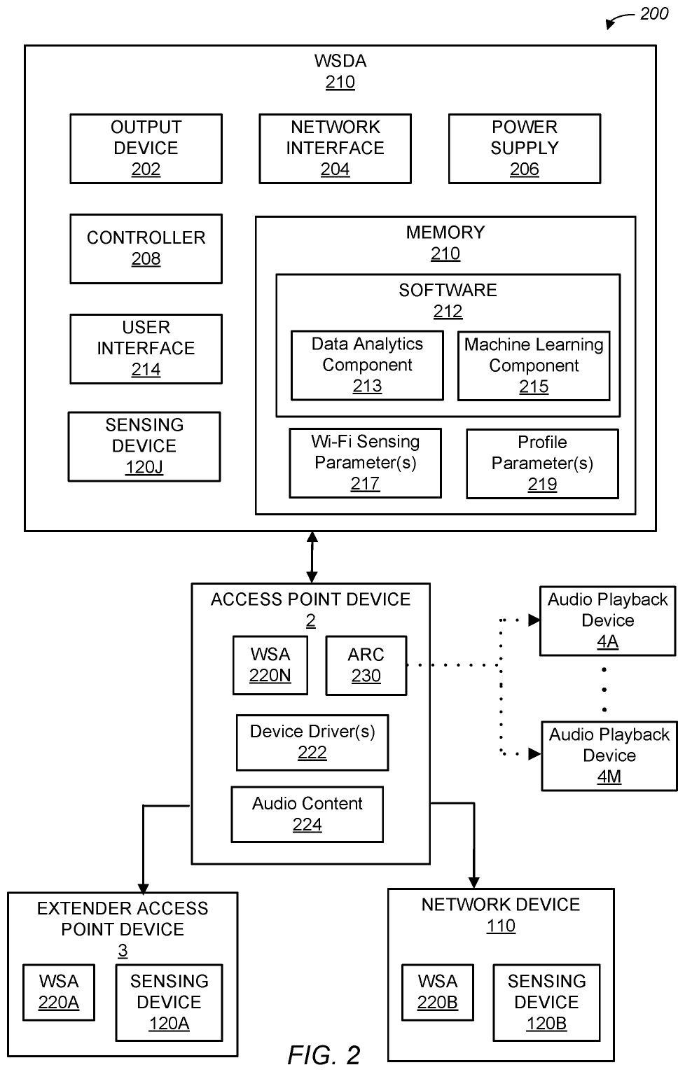

Network device 110 can connect to a client device 4 via a connection 7. A network device 110 can comprise any type of device that can connect to the network, for example, a Wi-Fi network 150 within network environment 100, including but not limited to, any of an access point device 2, an extender access point device 3, a computing device capable of Wi-Fi sensing, or any combination thereof. Connection 7 can utilize any one or more protocols discussed above with respect to connection 9. In one or more embodiments, a network device 110 can sense or otherwise identify, acknowledge and/or receive a Wi-Fi sensing parameter (such as Wi-Fi sensing parameter 217 of FIG. 2) associated with a user in the network 150. A Wi-Fi sensing parameter can be associated with or indicate the sensing of any one or more environmental indicators, such as any of a received signal strength indicator (RSSI), a neighbor report (for example, an IEEE 802.11k report), a sound (for example, a tone, any collection or combination of sounds whether audible or inaudible, a voice, any other sound, or any combination thereof), a vibration and/or a movement associated with a user, an environmental condition (such as a temperature, a humidity, a barometric pressure, a light level, any other condition, or a combination thereof), any other parameter associated with a presence of a user that can be sensed or detected, or any combination thereof. In one or more embodiments, any one or more network devices 110 can comprise a sensing device 120 and/or be coupled to a sensing device 120 via a connection 13 and/or 10. Connection 13 can be the same as or similar to the connection 7. For example, a network device 110A can be connected to an access point device 2 via a connection 10 and a network device 110B can be connected to an extender access point device 3 via a connection 11.

The connection 10 between the access point device 2 and the client device 4 can be implemented through a wireless connection that operates in accordance with, but is not limited to, any IEEE 802.11 protocols, for example, a connection that utilizes one or more channels. Additionally, the connection 10 between the access point device 2 and the client device 4 can also be implemented through a WAN, a LAN, a VPN, MANs, PANs, WLANs, SANs, a DOCSIS network, a fiber optics network (for example, FTTH, FTTX, or HFC), a PSDN, a global Telex network, or a 2G, 3G, 4G, 5G or 6G network, for example.

The connection 10 can also be implemented using a wireless connection in accordance with Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. One or more of the connections 10 can also be a wired Ethernet connection.

In general, it is contemplated by the present disclosure that the access point device 2, the extender access point devices 3, the network devices 110, the client devices 4, and the sensing device 120 include electronic components or electronic computing devices operable to receive, transmit, process, store, and/or manage data and information associated with the network environment 100, which encompasses any suitable processing device adapted to perform computing tasks consistent with the execution of computer-readable instructions stored in a memory or a computer-readable recording medium (for example, a non-transitory computer-readable medium).

Further, any, all, or some of the computing components in the access point device 2, the extender access point devices 3, the network devices 110, the client devices 4, and the sensing device 120 may be adapted to execute any operating system, including Linux, UNIX, Windows, MacOS, DOS, and ChromOS as well as virtual machines adapted to virtualize execution of a particular operating system, including customized and proprietary operating systems. The access point device 2, the extender access point devices 3, the network devices 110, the client devices 4, and the sensing device 120 are further equipped with components to facilitate communication with other computing and/or network devices over the one or more network connections to local and wide area networks, wireless and wired networks, public and private networks, and any other communication network enabling communication in the network environment 100.

FIG. 2 is a block diagram illustrating an audio playback routing system 200, according to one or more aspects of the present disclosure. The audio playback routing system 200 can be within or part of, for example, a network 150 of a network environment 100 of FIG. 1. The audio playback routing system 200 comprises a Wi-Fi sensing data analyzer (WSDA) 210, an access point device 2, one or more extender access point devices 3, one or more network devices 110, and a plurality of client devices 4 (referred to as audio playback devices 4A and 4B and collectively as audio playback device(s) 4).

The WSDA 210 can be any type of electronic apparatus and/or computing device, such as a network device 110 capable of processing one or more Wi-Fi sensing parameters received from one or more network devices 110 and/or one or more sensing devices 120. For example, the WSDA 210 can be or be part of a personal computer, a router, an access point device 2, an extender access point device 3, a network device 110, any other electronic apparatus, or a combination thereof. The WSDA 210 can comprise an output device 202, a network interface 204, a power supply 206, a controller 208, a memory 210, and a user interface 214. In one or more embodiments, the WSDA 210 is remote from the network 150, for example, the WSDA 210 can be cloud-based and/or be part of a network resource 6 of FIG. 1. In one or more embodiments, the WSDA 210 can be within the network 150 and/or comprise a sensing device 120 (such as sensing device 120J where J represents any number of sensing devices 120) for sensing one or more Wi-Fi sensing parameters 217 based on one or more profile parameters 219.

The power supply 206 supplies power to any one or more of the internal components of the WSDA 210, for example, through an internal bus. The power supply 206 can be a self-contained power source such as a battery pack with an interface to be powered through an electrical charger connected to an outlet (for example, either directly or by way of another device). The power supply 206 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The network interface 204 can include, but is not limited to, various network cards, interfaces, and circuitry implemented in software and/or hardware to enable communications with any one or more network devices 110 of the network environment 100 and/or the network 150, for example, an access point device 2, an audio playback device 4, an extender access point device 3, any other network device 110, or any combination thereof using any of the communication protocol(s) discussed with reference to FIG. 1. For example, the network interface 204 allows for communication between the WSDA 210 and access point device 2, any other network device 110, and/or one or more network resources 6. In one or more embodiments, the network interface 204 can provide indirect access to network resource 6 as illustrated in FIG. 1 or an indirect access to network resource 6 via a backchannel connection.

Output device 202 provides audio output, visual output, multi-media output, or any combination thereof. Output device 202 can comprise any of a speaker, a sound bar, an indicator (such as any visual indicator, for example, a light emitting diode), a display (such as a television, a monitor, a projector, and/or any other audio playback device, video playback device, or both), any other device that provides for an interface with a user, or any combination thereof. For example, output device 202 can comprise a speaker for playback of audio content 224 to a user and/or a display device for output of a graphical user interface associated with user interface 214.

Any one or more network devices 110 can comprise and/or be connected to a sensing device 120 that detects or senses one or more Wi-Fi sensing parameters 217. A sensing device 120 can be any type of sensing system or device including, but not limited to, any of a temperature sensor, a motion sensor, a voice user interface (for example, any of an audible response system, a voice and/or speech recognition system, a voice command device, or any combination thereof), a temperature sensor, a humidity sensor, a light sensor, a luminescence sensor, a barometric pressure sensor, a vibration sensor, an audio input or sound sensor (such as a microphone), any other system or device for Wi-Fi sensing so as to detect a presence or lack thereof of a user, or any combination thereof. In one or more embodiments, a sensing device 120J (where J represents any number of sensing devices 120) can be included as part of or internal to the WSDA 210 (as shown) and/or coupled to or part of a network device 110, extender access point device 3, and/or access point device 2. Any of the one or more Wi-Fi sensing parameters 217 collected or received from a sensing device 120 and/or any one or more network devices 110 (for example, a WSA 220 of a network device 110) can be stored in memory 210, communicated to a network resource 6, or both. In one or more embodiments, a network device 110 and/or a sensing device 120 can automatically, routinely, at timed intervals, and/or any other basis sense one or more Wi-Fi sensing parameters 217. In one or more embodiments, the network device 110 and/or the sensing device 120 can provide a prompt or a notification to a user requesting an auditory response such that if an auditory response is detected the network device 110 and/or sensing device 120 updates one or more Wi-Fi sensing parameters 217. For example, a user can respond to the notification using a voice command that is received at a sensing device 120 at the WSDA 210 and/or any other network device 110 within proximity of the user. Upon receipt of the voice command by the network device 110 and/or the sensing device 120, the network device and/or sensing device 120 can transmit and/or be requested to transmit the one or more Wi-Fi sensing parameters 217 to the WSDA 210 via a WSA 220 so that one or more packets associated with the audio content can be properly directed to one or more audio playback devices 4.

The user interface 214 includes, but is not limited to, any of one or more tactile inputs (for example, a push button, a selector, a dial, etc.), a camera, a keyboard, an audio input, for example, a microphone, a keypad, a liquid crystal display (LCD), a thin film transistor (TFT), a light-emitting diode (LED), a high definition (HD) or other similar display device including a display device having touch screen capabilities so as to allow interaction between one or more users and the network device 110, the network device 110 and one or more client devices 4 and/or one or more other network devices 110, or a combination thereof. For example, the user interface 214 can provide an interface associated with the configuration of one or more profile parameters 219 associated with a user.

The memory 210 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical drive, a hard disk or any other various layers of memory hierarchy. The memory 210 can be used to store any type of instructions, program, software, or algorithms including software 212 for interconnecting and/or processing one or more Wi-Fi sensing parameters 217 received from one or more network devices 110, such as the network devices 110A-110C, the access point device 2, the extender access point device 3, one or more sensing devices 120, any other network device 110 within the network environment 100, or any combination thereof. In one or more embodiments, software 212 includes one or more applications and/or computer-readable instructions for receiving one or more profile parameters 219 and/or one or more Wi-Fi sensing parameters 217, storing one or more profile parameters 219 and/or one or more Wi-Fi sensing parameters 217 in memory 210, and/or utilizing one or more profile parameters 219 and/or one or more Wi-Fi sensing parameters 217 to route audio content 224 to any network device 110 within the network 150, such as any of one or more client devices 4 (such as an audio playback device 4). In one or more embodiments, routing the audio content 224 requires routing the audio content 224 via an access point device 2, an extender access point device 3, a network device 110, any other network or electronic device within the network 150, or any combination thereof to a client device 4 so as to provide playback of the audio content within a proximity of a user.

In one or more embodiments, software 212 includes a data analytics component 213, a machine learning component 215, or both. The data analytics component 213 processes the one or more Wi-Fi sensing parameters 217 and determines a location of a user based on the one or more Wi-Fi sensing parameters 217. For example, the data analytics component 213 determines that a user has transitioned from one location with the network 150 to another location within the network 150 based on one or more Wi-Fi sensing parameters 217 (for example, one or more RSSI measurements) received from a first sensing device 120 at a first location and a second sensing device 120 at a second location. In one or more embodiments, the one or more Wi-Fi sensing parameters 217 can be compared to one or more network parameter thresholds associated with the one or more Wi-Fi sensing parameters 217. A network parameter threshold can be an RSSI threshold that indicates an RSSI that is indicative of a presence of a user such that a comparison of the RSSI threshold to the one or more RSSI measurements can be indicative of a presence of a user. For example, the WSDA 210 can perform a comparison so as to determine that an RSSI measurement is at, above, or both the RSSI threshold and thus determine that a user is present with proximity of the network device 110. The machine learning component 215 manages any one or more network configuration changes or modifications of network 150, for example, adding or removing any one or more network device 120. In one or more embodiments, the machine learning component 215 can adjust, alter, or otherwise change any of the one or more network parameter thresholds associated with any one or more Wi-Fi sensing parameters 217 based on one or more changes in the network, such as any of a change in number of users, RSSI, bandwidth, throughput, any other condition of the network, or a combination thereof.

The one or more profile parameters 219 can be associated with a particular user, a group of users, a network 150, any one or more network devices 110, sensing devices 120, audio playback devices 4, or any combination thereof. For example, the one or more profile parameters 219 can indicate a network parameter threshold associated with one or more Wi-Fi sensing parameters 217, a time period or time interval “t” for polling or requesting one or more network devices 110 and/or a sensing device 120 to perform a sensing or detection of one or more Wi-Fi sensing parameters 217. In one or more embodiments, the one or more profiles parameters 219 can be associated with one or more Wi-Fi sensing parameters 217 such that any one or more Wi-Fi sensing parameters 217 can be associated with a different time interval “t”. The one or more profile parameters 219 can also be associated with a volume control such that playback of the audio content 224 is, at least initially, at a volume associated with the profile parameter 219. For example, a profile parameter 219 can indicate that for audio content 224 directed to a particular audio playback device 4A the volume should be at least initially set at a certain level while another profile parameter 219 can indicate that the volume should be set at or to a certain level based on a detection or sensing of a number of users within proximity of the audio playback device 4A.

The one or more Wi-Fi sensing parameters 217 can comprise any one or more parameters associated with the presence or lack thereof of a user within proximity of an audio playback device 4, a network device 110 associated with an audio playback device 4, or both. For example, the one or more Wi-Fi sensing parameters 217 can comprise one or more environmental indicators that are to be sensed or detected and each of the one or more environmental indicators can be associated with any of one or more of a timestamp, a channel number, a channel bandwidth, a channel utilization, a channel state information (CSI), any other identifier associated with Wi-Fi sensed parameter, or any combination thereof.

Each profile parameter 219 can be associated with a location within a network environment 100, for example, a location within proximity of one or more network devices 110, an access point device 2, an extender access point device 3, a sensing device 120, an audio playback device 4, or any combination thereof. A location can correspond to a physical position within a network environment 100 where a user can be detected or sensing using a sensing device 120. In one or more embodiments, the WSDA 210 can query a network resource 6 for any one or more profile parameters 219 and/or receive one or more profile parameters 219 from the network resource 6.

The controller 208 controls the general operations of the WSDA 210 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 212 for altering, modifying or otherwise controlling one or more electronic devices in a network environment in accordance with the embodiments described in the present disclosure. Communication between any of the components (for example, 202, 204, 206, 210, 212, 214, 220, and 120) of the WSDA 210 can be established using an internal bus.

The WSDA 210 can connect to an access point device 2. The access point device 2 can any of receive audio content 224 from the WSDA 210, send audio content 224 to the WSDA 210, receive one or more instructions from the WSDA 210, or any combination thereof. The access point device 2 can comprise an audio routing controller (ARC) 230, a wi-fi sensing agent (WSA) 220, or both. In one or more embodiments, the ARC 230, the WSA 220, or both are included within or part of the WSDA 210. While FIG. 2 illustrates the WSDA extern to the access point device 2, the present disclosure contemplates that the WSDA can be part of or otherwise included within the access point device 2.

The ARC 230 interfaces with the WSDA 210 and any one or more device drivers 222 to control flow of one or more packets associated with audio content. For example, the ARC 230 directs the audio content 224 to one or more client devices 4 (such as any of audio playback devices 4A through 4M (collectively referred to as audio playback device(s) 4), where M represents any number of audio playback devices 4. For example, the ARC 230 can perform a scan of the network 150 to determine the location of the one or more audio playback devices 4 and/or proximity of the one or more audio playback devices 4 to one or more network devices 110. In one or more embodiments, the ARC 230 directs the audio content 224 for playback at a plurality of audio playback devices 4 based on an instruction or command from the WSDA 210. In one or more embodiments, the ARC 230 controls the routing of the audio content 224 by dropping the packets associated with the audio content 224 that are destined for a first one or more audio playback devices 4 while allowing routing of the packets associated with the audio content 224 destined for a second one or more audio playback devices 4. For example, the WSDA 210, based on one or more Wi-Fi sensing parameters 217 received from one or more WSAs 220, can send an instruction to the ARC 230 of the access point device 2 that is indicative of the location or movement of a user so that the ARC 230 can direct one or more packets associated with the audio content. For example, the ARC 230 can direct the one or more packets so as to cause any of playback an audio content, discontinue playback of an audio content, direct the one or more packets to a different network device 110 for playback of the audio content at any one or more audio playback devices 4, or any combination thereof.

The audio playback routing system 200 can comprise one or more WSAs 220A-220N (collectively referred to as WSA 220) disposed at or within the access point device 2 (illustrated as WSA 220N, where N represent any number of WSAs 220), the extender access point device 3 (illustrated as WSA 220A), a network device 110 (illustrated as WSA 220B), any other network device 110, or any combination thereof. The WSA 220 receives, collects, and/or senses one or more Wi-Fi sensing parameters 217 associated with a user. For example, the WSA 220 can sense an RSSI at a location. The RSSI can be sensed directly by the WSA 200 and/or from one or more sensing devices 120 within and/or external to the access point device 2, the extender access point device 3, and/or any other network device 110. In one or more embodiments, the same type of one or more Wi-Fi sensing parameter 217 are sensed and/or received by all of the WSAs 220 or one or more of the WSAs 220. The WSA 220 can transmit the one or more Wi-Fi sensing parameters 217 to the WSDA 210 directly and/or indirectly via the ARC 230 of the access point device 2. In one or more embodiments, the WSA 220 can store the one or more Wi-Fi sensing parameters 217 in a memory prior to transmission to the WSDA 210.

FIG. 3 illustrates a block diagram of a configuration of network devices 110 in a user environment 300, according to one or embodiments of the present disclosure. User environment 300 can include a network environment, for example network environment 100 of FIG. 1, such that user environment 300 includes a wireless network, such as a network 150 of FIG. 1, with one or more network devices 110 connected to the wireless network, such as one or more client devices 4A-4f (such as, client device 4A (for example, a mobile phone 4A), client device 4B (for example, a television 4B), a client device 4C (for example, a multi-media player 4C), and/or client devices 4D-4F (for example, speakers 4D-4F)), and/or one or more network devices 110A-H. User environment 300 can include one or more rooms or locations, for example, any of a first user location 302 (for example, a first bedroom 302), a second user location 304 (for example, a second bedroom 304), a third user location 306 (for example, a foyer 306), a fourth user location 308 (for example, a living room 308), a fifth user location 310 (for example, a media room 310), a sixth user location 312 (for example, a kitchen 312), a seventh user location 314 (for example, a patio 314), an eighth user location 316 (for example, a sun room 316), any other user location, or any combination thereof. The network device 110B can be an access point device 2 that controls the routing of audio content 224 to one or more audio playback devices 4, receives one or more Wi-Fi sensing parameters 217 associated with a sensing device 120 associated with network device 110B and/or any other network device 110. With respect to FIG. 3, network device 110B can be referred to as access point device 110B and access point device 110B can comprise a WSDA 210.

Any one or more users 350 (for example, one or more users 350A, 350B, 350C, 350D, 350E, 350F and/or 350G) can traverse from one user location to another user location throughout the user environment 300 as indicated by the dotted lines in FIG. 3. For example, a user 350A can enter user environment 300 at the foyer 306. User 350A can be within proximity of a network device 110A and an audio playback device 4A, for example, a mobile phone 4A. The user 350A can initiate the playback of audio content 224 at the mobile phone 4A at a foyer 306. User 350A can traverse the user environment 300 from the foyer 306 to a first bedroom 302. A WSA 220 of the network device 110B can receive a first one or more Wi-Fi sensing parameters 217 from the network device 110A. The first one or more Wi-Fi sensing parameters 217 can indicate that user 350 is no longer detected or sensed at or about the foyer 306, such as within a proximity of the network device 110A. Access point device 110B can include a WSDA 210 or can interface with a remote WSDA 210 such that a data analytics component 213 of the WSDA determines that the user 350 is no longer present at foyer 306 based on the first one or more Wi-Fi sensing parameters 217. The WSDA 210 can transmit an instruction to the audio playback device 4A to discontinue playback of the audio content 224 or to an ARC 230 of the access point device 110A to drop one or more packets associated with the audio content 224 that are destined or directed to the mobile phone 4A. As the user 350A traverses from the foyer 306 to the first bedroom 302, the presence of user 350 within proximity of the access point device 110B may be momentary such that the user's presence is not detected or sensed by a WSA220 of the access point device 110B or a WSA 220 of the access point device 110B can detect or sense the user 350A such that the WSDA 210 causes the audio content 224 to be directed to the television 4B at least temporarily while the presence of the user 350A is detected or sensed by the access point device 2. A WSA 220 of the network device 110E can sense or detect a second one or more Wi-Fi sensing parameters 217 that are indicative of the presence of the user 350A within proximity of the network device 110E at the first bedroom 302. The WSA 220 of the network device 110E can transmit the second one or more Wi-Fi sensing parameters 217 to the WSDA 210. The analytics component 213 of the WSDA 210 can determine the presence of user 350A at or about the first bedroom 302 and can transmit an instruction or otherwise direct one or more packets associated with the audio content 224 to the speaker 4E (for example, a speaker 4E) so as to cause playback the audio content 224. For example, the WSDA 210 can instruct an ARC 230 of access point device 110B to direct the one or more packets associated with the audio content 224 to the speaker 4E.

In one or more embodiments, a user 350B is sensed or detected by the access point device 110B. The user 350B can initiate playback of audio content 224 at the television 4B. The user 350B can transition to the second bedroom 304 where the user 350B is detected or sensed by a WSA 220 the network device 110D. Similar to the discussion with respect to user 350A, the WSDA 210 can cause one or more packets associated with the audio content 224 directed to television 4B to be dropped and direct the one or more packets associated with the audio content 224 requested by the user 350B to be directed or sent to speaker 4D in the second bedroom 304.

In one or more embodiments, a user 350C is in a kitchen 312. The network device 110C can detect or sense the user 350C. As no audio playback devices 4 are within proximity of the network device 110C, The WSDA 210 does not direct an audio content 224 associated with user 350C to any client device 4. The user 350C can transition from the kitchen 312 to the media room 310 where the user 350C joins users 350D and 350E. The network device 110F can detect or sense the presence of an additional user 350C and send a third one or more Wi-Fi sensing parameters 217 to the WSDA 210, for example, to the access point device 110B. The WSDA 210 can send an instruction to the ARC 230 of the access point device 110B to cause the media center 4C to playback audio content 224 associated with the user 350C and/or users 350D and/or 350E based on the third one or more Wi-Fi sensing parameters 217, the one or more profile parameters 219, or both. The one or more profile parameters 219 can indicate a volume level for the medica center 4C. For example, the volume level associated with the detection or sensing of a plurality of users 350 can be higher than that for a single user 350. In one or more embodiments, the instruction includes a volume level for the audio content 224 based on at least one of the one or more profile parameters 219.

In one or more embodiments a network device 110G and/or 110H can be disposed at an outside location, for example, a patio 314 and/or a sunroom 316, respectively. The patio 314 may not have an audio playback device such that when the user 350F is detected or sensed by the network device 110G no audio content is sent to any audio playback device. User 350G, though, can be detected by a network device 110H. Network device 110H can send a fourth one or more Wi-Fi sensing parameters 217 to the WSDA 210 similar to the discussion of any of network devices 110A, 110B, and 110C. As user 350G is at an outside location, the one or more profile parameters 219 associated with the network device 110H and/or client device 4F can indicate a volume level that is sufficient for a user 350 to hear the audio content. For example, a sunroom 316 can be a quiet location such that the volume level should be relatively low or can be rather loud location with outside noise such that the volume level should be relatively high.

In one or more embodiments, a user 350 can be remote from the user environment 300 and can utilize the user interface 214 to initiate the playback of audio content at one or more audio playback devices 4 associated with a network device 110 if a local user 350 is sensed or detected by the WSDA 210 based one or more Wi-Fi sensing parameters 217 associated with the network device 110.

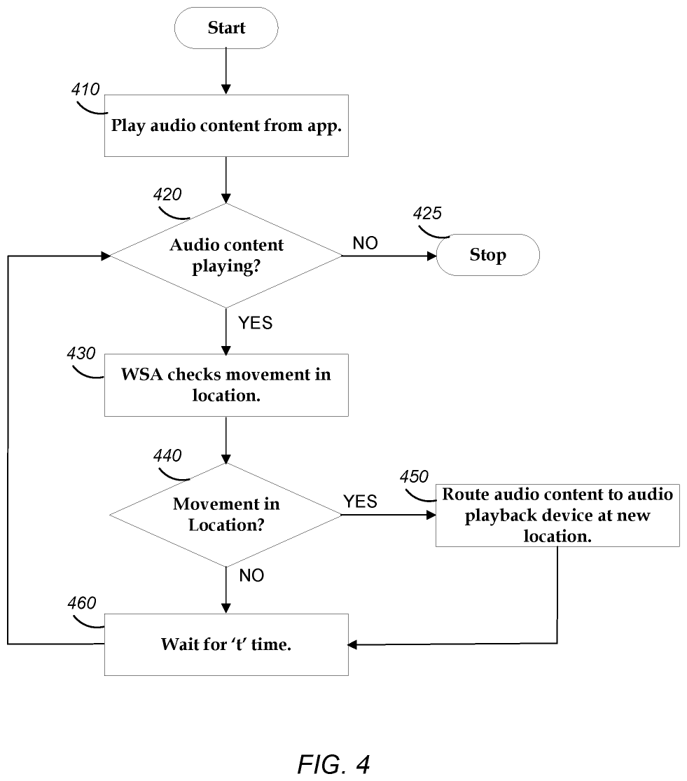

FIG. 4 is a flow diagram illustrating a method for routing of audio content 224 for playback at an audio playback device 4 within a network 150, according to one or more aspects of the present disclosure. The user environment 300 associated with one or more users 350 can be enhanced by providing the playback of audio content 224 at one or more client devices 4 based on one or more Wi-Fi sensing parameters 217 associated with a network device 110 in proximity of the one or more client devices 4.

At 410, an application associated with a user 350 is utilized to playback audio content 224 at a first client device 4 of one or more client devices 4 at an initial location. At step 420 it is determined if the audio content 224 is playing at the first client device 4. If audio content 224 is not playing at the first client device 4, the method stops at 425. If audio content 224 is playing at the first client device 4, the WSA 220 associated with a first network device 110 in proximity of the first client device 4 checks movement in location of user 350. For example, the WSA 220 of the network device 110 receives and/or requests one or more Wi-Fi sensing parameters 217 associated with the first network device 110 and transmits the one or more Wi-Fi sensing parameters 217 to the WSDA 210 via the access point device 2. At 440, the WSDA 210 determines if there is movement in the location of a user 350 based on the one or more Wi-Fi sensing parameters 217. If the WSDA 210 determines movement by the user 350, at 450 the audio content 224 is routed to a second audio playback device at the new location for the user 350. For example, a second network device 110 can sense or detect one or more Wi-Fi sensing parameters 217 associated with the second network device 110 and send to the WSDA 210 via the access point device 2 one or more Wi-Fi sensing parameters 217, for example, updated one or more Wi-Fi sensing parameters 217. The WSDA 210 can determine, based on the updated one or more Wi-Fi sensing parameters 217, a second client device 4 within proximity of the second network device 110 so as to cause playback of the audio content 224 to continue at the second client device 4. If no movement in location is determined at 440 or after routing the audio content at 405, the method continues at 460. At 460, the WSDA 210 waits of suspends operation for a time “t”, where “t” represents any value of time, such as milliseconds, seconds, minutes, etc. The one or more profile parameters 219 can be associated with the time “t” such that the WSDA 210 determines the time “t” based on at least one of the one or more profile parameters 219. After the expiration of time “t”, the method continues at 420 and the process is repeated.

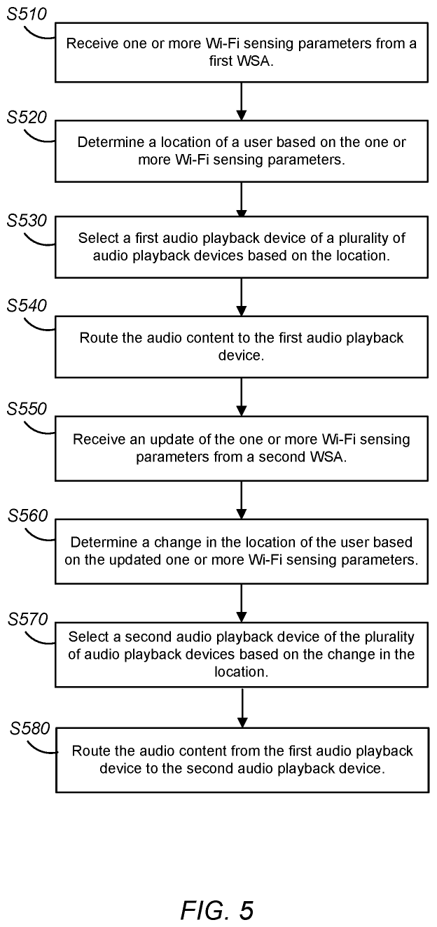

FIG. 5 is a flow chart illustrating a method for playback of audio content 224, according to one or more aspects of the present disclosure. The WSDA 210 may be programmed with one or more computer-readable instructions such as a software or program 212 that when executed by a controller 208 cause the playback of audio content 224 based on one or more Wi-Fi sensing parameters 217 received from one or more WSAs 220 associated with one or more network devices 110. In FIG. 5, it is assumed that any one or more of the network devices 110 and/or WSDA 210 include their respective controllers and their respective software stored in their respective memories, as discussed above in connection with FIGS. 1-4, which when executed by their respective controllers perform the functions and operations in accordance with the example embodiments of the present disclosure (for example, including providing a calibration for a sound system). While the steps S510-S580 are presented in a certain order, the present disclosure contemplates that any one or more steps can be performed simultaneously, substantially simultaneously, repeatedly, in any order or not at all (omitted).

At step S510, the WSDA 210 receives one or more Wi-Fi sensing parameters 217. The one or more Wi-Fi sensing parameters 217 are associated with a first WSA 220 of a first network device 110 connected to the network. The first WSA 220 can be located at any location within the network. The one or more Wi-Fi sensing parameters 217 can comprise any of a timestamp, a received signal strength indicator, a neighbor report, a channel number, a channel bandwidth, a channel utilization, a channel state information, or any combination thereof.

At step S520, the WSDA 210 determines a location of a user based on the one or more Wi-Fi sensing parameters 217. For example, the one or more Wi-Fi sensing parameters 217 can be associated with RSSI at the location of the first WSA 220 and based on the RSSI the WSDA 210 can determine whether a user is present within a proximity of the first WSA 220. In one or more embodiments, the WSDA 210 can determine the presence of a user based on one or more Wi-Fi sensing parameters 217 associated with one or more network devices 110.

At step S530, the WSDA 210 selects a first audio playback device 4 of a plurality of audio playback devices connected to the network. The first audio playback device 4 is associated with the first network device 110. For example, the first audio playback device 4 can be in wireless communication with the first network device 110 such that the first network device 110 can transmit audio content to the first audio playback device 4 for playback at the first audio playback device 4.

At S540, the WSDA 210 routes the audio content to the first audio playback device. For example, the WSDA 210 can send a first routing instruction to the ARC 230 of an access point device 2. The first routing instruction can cause the ARC 230 to direct one or more packets associated with the audio content to the first audio playback device 4.

At step S550, the WSDA 210 receives an update of the one or more Wi-Fi sensing parameters 217. The updated one or more Wi-Fi sensing parameters 217 are associated with a second WSA 220 of a second network device 110 connected to the network. The updated one or more Wi-Fi sensing parameters 217 are associated with a second WSA 220 of a second network device 110 connected to the network. The second WSA 220 can be located at any location within the network. For example, the Wi-Fi sensing parameters 217 can be indicative of an RSSI that indicates the presence of a user. The user can transition to a different location where the second WSA 220 can sense an RSSI that indicates the presence of the user at the new location.

At step S560, the WSDA 210 determines a change in the location of the user based on the updated one or more Wi-Fi sensing parameters 217 with the new sensed RSSI associated with the second WSA 220 of a second network device 110 connected to the network. The WSA 220 can update the one or more sensing parameters 217 with this RSSI associated with the second WSA 220. In one or more embodiments, the change in the location of the user is determined based on a comparison of the updated one or more Wi-Fi sensing parameters 217 to one or more network parameter thresholds.

At S570, the WSDA 210 selects a second audio playback device 4 of the plurality of audio playback devices 4 based on the change in the location determined at step S560. In one or more embodiments, the second audio playback device 4 can comprise a plurality of audio playback devices 4 such that, for example, multiple speakers associated with the second network device 110 can be selected.

At S580, the WSDA 210 can route the audio content from the first audio playback device 4 to the second audio playback device 4. For example, the WSDA 210 can send a second routing instruction an ARC 230 of an access point device 2 within the network to cause the ARC 230 to route the audio content. In one or more embodiments, the routing the audio content from the first audio playback device to the second audio playback comprises a volume level based on at least one of one or more profile parameters 219 associated with any of the user, the first network device, the second network device, the second audio playback device, or any combination thereof.

With respect to step S580 and/or step S540, the routing the audio content can comprise discontinuing or dropping one or more packets associated with the audio content such that the audio content is not received by any or one or more network devices 110. For example, the WSDA 210 can determine that a user is not within proximity of the network and discontinue routing of the audio content based on this determination. In one or more embodiments, the WSDA the determination that the user is not within proximity of the network is based on the determination of an expiration of a time period. In one or more embodiments, the time period is based on a profile parameter 219.

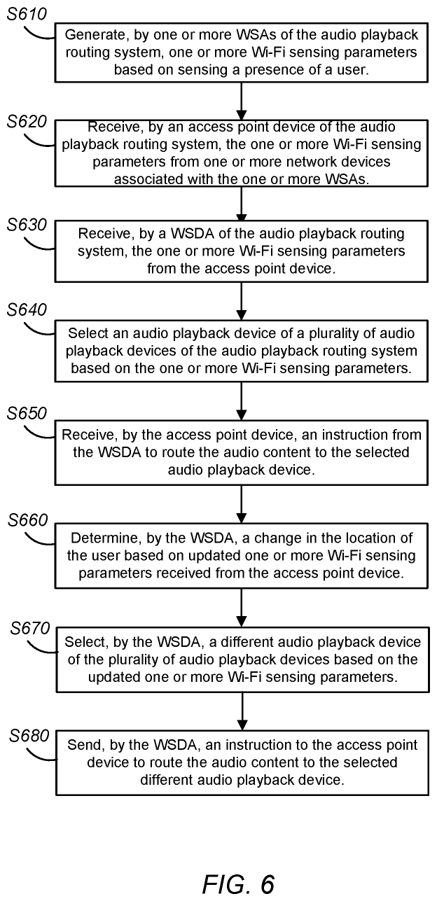

FIG. 6 is a flow chart illustrating an audio playback routing system 200 for routing audio content within a network, according to one or more aspects of the present disclosure. The WSDA 210 may be programmed with one or more computer-readable instructions such as a software or program 212 that when executed by a controller 208 cause the routing of audio content 224 based on one or more Wi-Fi sensing parameters 217 received from one or more WSAs 220 associated with one or more network devices 110. In FIG. 6, it is assumed that any one or more of the network devices 110 and/or WSDA 210 include their respective controllers and their respective software stored in their respective memories, as discussed above in connection with FIGS. 1-4, which when executed by their respective controllers perform the functions and operations in accordance with the example embodiments of the present disclosure (for example, including providing a calibration for a sound system). While the steps S610-S680 are presented in a certain order, the present disclosure contemplates that any one or more steps can be performed simultaneously, substantially simultaneously, repeatedly, in any order or not at all (omitted).

At step S610, an audio playback routing system, such as audio playback routing system 200 of FIG. 2, can sense the presence of a user. For example, one or more WSAs 220 of the audio playback routing system can generate one or more Wi-Fi sensing parameters 217 based on sensing a presence of a user. The one or more WSAs 220 can be part of any type of network device, such as any of an extender access point device 3, any other network device 110, or a combination thereof. In one or more embodiments, a WSA 220 can be connected to a sensing device 120 and receive one or more Wi-Fi sensing parameters 217 from the sensing device 120.

At step S620, an access point device 2 of the audio playback routing system receives the one or more Wi-Fi sensing parameters 217 from step S610 from one or more network devices 110 associated with the one or more WSAs 220 of the one or more network devices 110. As illustrated in FIG. 2, the one or more WSAs 220 can be part of or included within the one or more network devices. The one or more network devices 110 can be wired and/or wireless directly and/or indirectly connected to the access point device 2. In one or more embodiments, the access point device 2 requests at timed or periodic intervals the one or more Wi-Fi sensing parameters 217 from the one or more WSAs 220, such as by polling each of the one or more network devices 110. In one or more embodiments, the WSAs 220 send the one or more Wi-Fi sensing parameters 217 automatically at timed or periodic intervals, in real-time, and/or substantially in real-time to the access point device 2.

At step S630, a WSDA 210 of the audio playback routing system receives the one or more Wi-Fi sensing parameters 217 from the access point device 2. The WSDA 210 can be located remote from the access point device 2 such that the WSDA 210 is connected wired and/or wireless directly and/or indirectly to the access point device 2 or included within or as part of the access point device 2. The WSDA 210 can perform an analysis of the one or more Wi-Fi sensing parameters 217, for example, by an ARC 230 of the WSDA 210. The WSDA 210 maintains one or more patterns under one or more different conditions. For example, measurements of the one or more Wi-Fi sensing parameters 217 such as measurements for when a user is present at a location, no user is at a location, a door closed at a location, a door open at a location, any other pattern associated with the one or more Wi-Fi sensing parameters 217, or any combination thereof. In one or more embodiments, the WSDA 210 maintains or analyzes one or more patterns to any of the one or more Wi-Fi sensing parameters 217 to determine whether a user is present at a location.

At step S640, the WSDA 210 selects an audio playback device 4 of the plurality of audio playback devices 4 of the audio playback routing system based on the one or more Wi-Fi sensing parameters 217. The plurality of audio playback devices 4 can be disposed at one or more locations within the network, for example, as discussed with reference to FIG. 3. The plurality of audio playback devices 4 can be connected directly and/or indirectly to one or more network devices 110 such that the one or more network devices 110 can transmit audio content 224 to the plurality of audio playback devices 4. In one or more embodiments, one or more network devices 110 can be selected by the WSDA 210 based on the sensed presence of a user as indicated by any of the one or more Wi-Fi sensing parameters 217.

At step S650, the access point device 2 receives a first routing instruction from the WSDA 210 to route the audio content to the selected audio playback device 4. The instruction can include any of an identification of the network device 110 associated with the selected audio playback device 4, an identification of the selected audio playback device 4, a priority level for the playback of the audio content, any other information, or a combination thereof. In one or more embodiments, the WSDA 210 and/or the access point device 2 controls routing of the audio content based on one or more profile parameters 219.

At step S660, the WSDA 210 can determine a change in the location of the user based on updated one or more Wi-Fi sensing parameters 217 received from the access point device 2. The one or more Wi-Fi sensing parameters 217 can be associated with any of the network device 110 associated with the one or more Wi-Fi sensing parameters 217, any other network device 110, or both. For example, the WSDA 210 can receive a first one or more Wi-Fi sensing parameters 217 from a first network device associated with a first audio playback device 4 and a second one or more Wi-Fi sensing parameters 217 from a second network device associated with a second audio playback device 4 and a third audio playback device 4. The WSDA 210 can compare the received first and/or second one or more Wi-Fi sensing parameters 217 to a network parameter threshold associated with at least one of the one or more Wi-Fi sensing parameters 217 and/or the updated one or more Wi-Fi sensing parameters 217 and based on the comparison determine whether a user is in proximity of the network devices 110. In one or more embodiments, the WSDA 210 determines that the user is not within proximity of the network and/or any one or more network devices 110 based on any received one or more network parameters 217. The WSDA 210 can then send a discontinue routing instruction to the access point device 2 to cause the access point device 2 to discontinue routing of the audio content 224, or one or more packets associated with the audio content 224, based on the determination that the user is not within proximity of the network and/or one or more network devices 110.

At step S670, the WSDA 210 selects a different audio playback device 4 of the plurality of audio playback devices 4 based on the updated one or more Wi-Fi sensing parameters 217. In one or more embodiments, the different audio playback device 4 comprises one or more audio playback devices 4. The WSDA 210 can select the different audio playback device 4 based on the comparison discussed with reference to step S660.

At step S680, the WSDA 210 sends a second routing instruction to the access point device to route the audio content 224 to the selected different audio playback device 4. In one or more embodiments, the second routing instruction does not discontinue playback at the audio playback device 4 selected in step S640 such that the audio content 224 is routed to both the audio playback device 4 and the different audio playback device 4. In one or more embodiments, the second routing instruction or an additional routing instruction causes the access point device 2 to discontinue or drop routing one or more packets associated with the audio content 224 to the audio playback device 4. The first routing instruction, the second routing instruction, or both can cause the access point device to direct and/or route the one or more packets to a selected one or more audio playback devices 4.

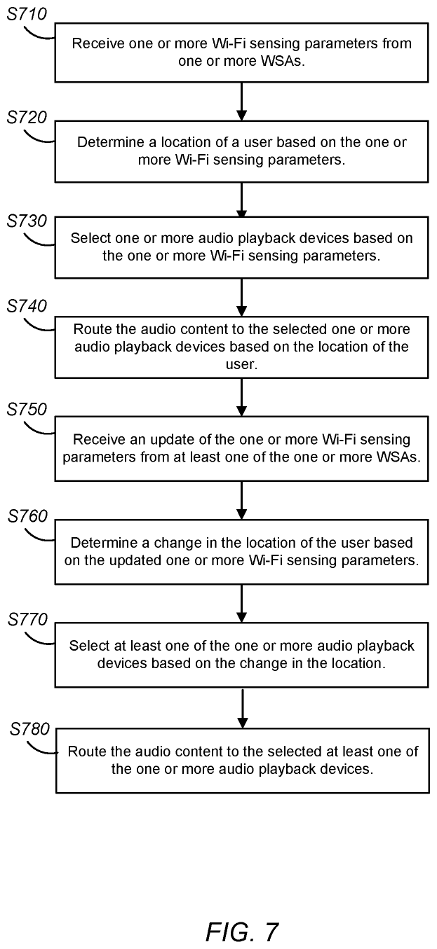

FIG. 7 is a flow chart illustrating a method for an access point device 2 to route an audio content 224 within a network, according to one or more aspects of the present disclosure. The access point device 2 can comprise a WSDA 210 and can be programmed with one or more computer-readable instructions such as a software or program 212 that when executed by a controller 208 cause the routing of audio content 224 based on one or more Wi-Fi sensing parameters 217 received from one or more WSAs 220 associated with one or more network devices 110. In FIG. 7, it is assumed that any one or more of the network devices 110 and/or WSDA 210 include their respective controllers and their respective software stored in their respective memories, as discussed above in connection with FIGS. 1-4, which when executed by their respective controllers perform the functions and operations in accordance with the example embodiments of the present disclosure (for example, including providing a calibration for a sound system). While the steps S710-S780 are presented in a certain order, the present disclosure contemplates that any one or more steps can be performed simultaneously, substantially simultaneously, repeatedly, in any order or not at all (omitted).

At step S710, an access point device 2 receives one or more Wi-Fi sensing parameters 217 from one or more WSAs 220. The one or more WSAs 220 are associated with a network device, such as any of an access point device 2, an extender access point device 3, any other network device 110, or a combination thereof. For example, a WSA 220 can be within or part of a network device 110. A WSA 220 can receive the one or more Wi-Fi sensing parameters 217 from an associated sensing device 120, for example, as discussed with reference to FIG. 6.

At step S720, the access point device 2 determines a location of a user based on the one or more Wi-Fi sensing parameters 217. For example, the access point device 2 can comprise a WSDA 210. A data analytics component 213 of the WSDA 210 can determine the location of the user based on the one or more Wi-Fi sensing parameters 217. The data analytics component 213 can also utilize previously stored data, for example, data stored in a memory 210, a network resource 6 (such as a remote repository), any other stored data, or a combination thereof.

At step S730, the access point device 2, for example, via the WSDA 210, selects one or more audio playback devices 4 based on the one or more Wi-Fi sensing parameters 217, the analysis performed by the data analytics component 213, or both. The one or more audio playback devices 4 are associated with the one or more network devices 110 as discussed with reference to FIGS. 5 and 6.

At step S740, the access point device 2 routes the audio content 224 of the selected one or more audio playback devices 4 based on the location of the user determined at step S720. For example, an ARC 230 of the access point device 2 receives a routing instruction from the WSDA 210 that causes the ARC 230 to route the audio content 224 to the selected one or more audio playback devices 4.

At step S750, The access point device 2 receives an update, for example, at the ARC 230, of the one or more Wi-Fi sensing parameters 217 from at least one of the one or more WSAs 220. The updated one or more Wi-Fi sensing parameters 217 are then used by the access point device 2 at step S760 to determine a change in the location of the user. For example, the data analytics component 213 can determine the change in the location of the user as discussed with reference to step S660 of FIG. 6.

At step S770, the access point device 2 selects at least one of the one or more audio playback devices 4 based on the change in the location. For example, the data analytics component 213 can determine the changed location and based on this changed location select an audio playback device that is within proximity of a network device 110 associated with the changed location. Selection of an audio playback device 4 at step S770 and/or step S730 can be based on one or more network parameter thresholds associated with at least one of the one or more Wi-Fi sensing parameters 217.

At step S780, the access point device 2 routes the audio content 224 to the selected at least one of the one or more audio playback devices 4. For example, an ARC 230 can drop, discontinuing routing, direct, or otherwise route one or more packets associated with the audio content 224 to the selected at least one of the one or more audio playback devices 4. For example, if the data analytics component 213 determines that the user is not within proximity of the network and/or a network device 110, the WSDA 210 can instruct the ARC 230 to discontinue or otherwise drop the one or more packets associated with the audio content 224 such that the audio content 224 is no longer played back at an audio playback device 4.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A Wi-Fi sensing data analyzer (WSDA) device to route an audio content within a network comprising:
a memory storing one or more computer-readable instructions; and
a processor connected to the memory, the processor configured to execute the one or more computer-readable instructions to:
receive one or more Wi-Fi sensing parameters, wherein the one or more Wi-Fi sensing parameters are associated with a first Wi-Fi sensing agent (WSA) of a first network device connected to the network;
determine a location of a user based on the one or more Wi-Fi sensing parameters;
select a first audio playback device of a plurality of audio playback devices connected to the network based on the location, wherein the first audio playback device is associated with the first network device;
route the audio content to the first audio playback device;
receive an update of the one or more Wi-Fi sensing parameters, wherein the updated one or more Wi-Fi sensing parameters are associated with a second WSA of a second network device connected to the network;
determine a change in the location of the user based on the updated one or more Wi-Fi sensing parameters;
select a second audio playback device of the plurality of audio playback devices associated with the second network device based on the change in the location of the user, wherein the first audio playback device is associated with the first network device; and
route the audio content from the first audio playback device to the second audio playback device.

2. The WSDA device of claim 1, wherein the routing the audio content from the first audio playback device to the second audio playback comprises any of a volume level based on at least one of one or more profile parameters associated with any of the user, the first network device, the second network device, the second audio playback device, or a combination thereof.

3. The WSDA device of claim 1, wherein the determining the change in the location of the user is based on a comparison of the updated one or more Wi-Fi sensing parameters to one or more network parameter thresholds.

4. The WSDA device of claim 1, wherein routing the audio content comprises sending a routing instruction to an audio routing controller (ARC) of an access point device within the network, wherein the routing instruction is indicative of routing of the audio content.

5. The WSDA device of claim 1, wherein the processor is further configured to execute the one or more instructions to:
discontinue routing of the audio content based on a determination that the user is not within proximity of the network.

6. The WSD device of claim 5, wherein the processor is further configured to execute the one or more instructions to:
determine an expiration of a time period; and
wherein the determining that the user is not within proximity of the network is based on the expiration of the time period.

7. The WSDA device of claim 1, wherein the one or more Wi-Fi sensing parameters comprise any of a timestamp, a received signal strength indicator, a neighbor report, a channel number, a channel bandwidth, a channel utilization, a channel state information, or a combination thereof.

8. A method for a Wi-Fi sensing data analyzer (WSDA) device for routing an audio content within a network, the method comprising:
receiving one or more Wi-Fi sensing parameters, wherein the one or more Wi-Fi sensing parameters are associated with a first Wi-Fi sensing agent (WSA) of a first network device connected to the network;
determining a location of a user based on the one or more Wi-Fi sensing parameters;
selecting a first audio playback device of a plurality of audio playback devices connected to the network based on the location, wherein the first audio playback device is associated with the first network device;
routing the audio content to the first audio playback device;
receiving an update of the one or more Wi-Fi sensing parameters, wherein the updated one or more Wi-Fi sensing parameters are associated with a second WSA of a second network device connected to the network;
determining a change in the location of the user based on the updated one or more Wi-Fi sensing parameters;
selecting a second audio playback device of the plurality of audio playback devices associated with the second network device based on the change in the location of the user, wherein the first audio playback device is associated with the first network device; and
routing the audio content from the first audio playback device to the second audio playback device.

9. The method of claim 8, wherein the routing the audio content from the first audio playback device to the second audio playback comprises any of a volume level based on at least one of one or more profile parameters associated with any of the user, the first network device, the second network device, the second audio playback device, or a combination thereof.

10. The method of claim 8, wherein the determining the change in the location of the user is based on a comparison of the updated one or more Wi-Fi sensing parameters to one or more network parameter thresholds.

11. The method of claim 8, wherein routing the audio content comprises sending a routing instruction to an audio routing controller (ARC) of an access point device within the network, wherein the routing instruction is indicative of routing of the audio content.

12. The method of claim 8, further comprising discontinuing routing of the audio content based on a determination that the user is not within proximity of the network.

13. The method of claim 12, further comprising:
determining an expiration of a time period; and
wherein the determining that the user is not within proximity of the network is based on the expiration of the time period.

14. The method of claim 8, wherein the one or more Wi-Fi sensing parameters comprise any of a timestamp, a received signal strength indicator, a neighbor report, a channel number, a channel bandwidth, a channel utilization, a channel state information, or a combination thereof.

15. A non-transitory computer-readable medium of a Wi-Fi sensing data analyzer (WSDA) device storing one or more instructions for routing an audio content within a network, which when executed by a processor of the WSDA device, cause the WSDA device to perform one or more operations comprising:
receiving one or more Wi-Fi sensing parameters, wherein the one or more Wi-Fi sensing parameters are associated with a first Wi-Fi sensing agent (WSA) of a first network device connected to the network;
determining a location of a user based on the one or more Wi-Fi sensing parameters;
selecting a first audio playback device of a plurality of audio playback devices connected to the network based on the location, wherein the first audio playback device is associated with the first network device;
routing the audio content to the first audio playback device;
receiving an update of the one or more Wi-Fi sensing parameters, wherein the updated one or more Wi-Fi sensing parameters are associated with a second WSA of a second network device connected to the network;
determining a change in the location of the user based on the updated one or more Wi-Fi sensing parameters;
selecting a second audio playback device of the plurality of audio playback devices associated with the second network device based on the change in the location of the user, wherein the first audio playback device is associated with the first network device; and
routing the audio content from the first audio playback device to the second audio playback device.

16. The computer-readable medium of claim 15, wherein the routing the audio content from the first audio playback device to the second audio playback comprises any of a volume level based on at least one of one or more profile parameters associated with any of the user, the first network device, the second network device, the second audio playback device, or a combination thereof

17. The computer-readable medium of claim 15, wherein the determining the change in the location of the user is based on a comparison of the updated one or more Wi-Fi sensing parameters to one or more network parameter thresholds.

18. The computer-readable medium of claim 15, wherein routing the audio content comprises sending a routing instruction to an audio routing controller (ARC) of an access point device within the network, wherein the routing instruction is indicative of routing of the audio content.

19. The computer-readable medium of claim of claim 15, wherein the one or more computer-readable instructions when executed by the processor further cause the WSDA to perform one or more operations comprising:
discontinuing routing of the audio content based on a determination that the user is not within proximity of the network.

20. The computer-readable medium of claim 19, wherein the determining that the user is not within proximity of the network is based on the expiration of a time period.
